(19) United States
(12) Patent Application Publication
(10) Pub. No.: US 2014/0116851 A1
(43) Pub. Date: May 1, 2014

(54) CONVEYOR APPARATUS

(71) Applicant: Industrial Technology Research Institute, Hsinchu (TW)

(72) Inventors: Guo-Shing Huang, Hsinchu County (TW); Chih-Chiang Lu, New Taipei City (TW); Chang-Chou Li, Tainan City (TW); Chih-Yu Ke, Pingtung County (TW); Chin-Lung Liu, Kaohsiung County (TW)

(73) Assignee: Industrial Technology Research Institute, Hsinchu (TW)

(21) Appl. No.: 13/901,573

(22) Filed: May 24, 2013

Related U.S. Application Data
(60) Provisional application No. 61/719,510, filed on Oct. 29, 2012.

(30) Foreign Application Priority Data
Dec. 24, 2012 (TW) 101149584

(51) Int. Cl. B65G 25/06

(52) U.S. Cl. CPC B65G 25/06
USPC 198/750.1

(57) ABSTRACT

A conveyor apparatus including a control module, an unwinding module, at least one tension sensing module, and a rewinding module is provided. The tension sensing module includes a load cell disposed between a set of rollers. An objet is conveyed along a conveying direction perpendicular to an axis of the roller. A wrap angle is formed by the object and the roller with a fulcrum of the loadi cell served as a center, and the wrap angle is less than 180°. The rewinding and unwinding modules have different actuating units electrically connected to the control module respectively, such that the object is wound or unwound by the rewinding and the unwinding modules.

### CROSS-REFERENCE TO RELATED APPLICATION

This application claims the priority benefits of U.S. provisional application Ser. No. 61/719,510, filed on Oct. 29, 2012 and Taiwan application serial no. 101149584, filed on Dec. 24, 2012. The entirety of each of the above-mentioned patent applications is hereby incorporated by reference herein and made a part of this specification.

### BACKGROUND OF THE DISCLOSURE

1. Field of the Disclosure

The disclosure generally relates to a conveyor apparatus.

2. Description of Related Art

Glasses can be bent when the thickness is decreased to a certain degree and formed a flexible glass having properties of flexibility and high hardness, and become applicable to planar substrates for electronic papers (e-Paper), and protecting covers, contact sensing devices, solid state light emitting devices, electronic devices and the like for photovoltaic modules.

The materials of flexible substrates can also be glasses, polymers, metals or the like in the application.

Presently, thin glasses can be conveyed by the application of roll-to-roll method. Although the flexible glasses already have a certain degree of flexibility due to the ultra-thin thickness, they still have hard and brittle properties, and thus the strength of the flexible glasses may be reduced 2 to 4 times because of the stress concentration generated due to the micro-crack on edge, surface crack or scratch. Any unstable conveying force or force of dragging and torsion may cause the thin glass to be broken. Two important issues have to be solved when the flexible glasses are conveyed by using the roll-to-roll method, then the possibility of breakage of the flexible glasses during conveying can be reduced. One issue is the overstress including over-tension and conveying misalignment during conveying process of the flexible glasses, and the other issue is the stress fluctuation of the flexible glasses being repeatedly subjected to tension force and compression force.

The misalignment of flexible glasses during conveying process may lead to wavy winding, knurl or being disorder of side edge of the substrates, wrinkling or even breakage when the flexible substrates are wound. Moreover, for the flexible high-precision electronic products, since the misalignment of the flexible substrate during the conveying process restricts high-precision manufacturing process to be fulfilled, high-precision requirement cannot be satisfied.

Since in the roll-to-roll production line the flexible substrates have to be conveyed and changed directions by using a plurality of rollers, the flexible substrates are usually sandwiched and wound among the rollers. Then, the upper and lower surfaces of the flexible substrates are contact with the rollers and the upper and lower surfaces of the flexible substrates are subjected to the tensile and compressive forces. Thus, the flexible substrates may be taken fluctuated tensile and compressive stress and broken.

### SUMMARY OF THE DISCLOSURE

The disclosure provides a conveyor apparatus capable of preventing the upper and lower surfaces of an object being subjected to a tensile and compressive force during the conveying process of the object, and providing capability of the processed surface not contact with rollers and aligning the conveying path.

The disclosure provides a conveyor apparatus suitable for conveying an object along a conveying path. The conveyor apparatus includes a control module, an unwinding module, at least one tension sensing module and a rewinding module. The unwinding module includes a first actuating unit, wherein the first actuating unit is electrically connected to the control module. The object is adapted to be wound around the unwinding module and unwound via the first actuating unit. The at least one tension sensing module is disposed on the conveying path, and each of the tension sensing modules includes a set of rollers and a load cell. The load cell is disposed at the set of rollers and electrically connected to the control module, and the object is conveyed along the set of rollers and forms a wrap angle smaller than 180 degrees. The rewinding module includes a second actuating unit, wherein the second actuating unit is electrically connected to the control module. The object is adapted to be wound into the rewinding module via the second actuating unit.

In the conveyor apparatus of the disclosure, the conveying tension of the object between the rewinding module and the unwinding module is determined by the rotational speed or torque of the first actuating unit and the second actuating unit controlled by the control module. Via the set of rollers an included angle is formed and called the warp angle. The load cell can detect the magnitude of the tension of the object under the wrap angle and feed back to the control module, so that the tension of the object can be controlled to be in a certain range by the control module, so that the object is stably conveyed. In the conveyor apparatus of the disclosure, through the misalignment guiding module sensing the offset status of the object and driving the unwinding module or the rewinding module to move to a reverse direction of the offset direction, the misalignment of the object can be reduced. The object is contact with the first set of rollers and the second set of rollers by a specific wrap angle, so as to reduce the possibility of breakage occurrence of the object when the object is alternately subjected to a tensile and compressive force during the conveying process, and thus the processed surface does not contact with the rollers to prevent the process failure.

In order to make the aforementioned and other features of the disclosure more comprehensible, embodiments accompanying figures are described in detail below.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 schematically shows a perspective view of a conveyor apparatus according to an exemplary embodiment of the disclosure.

FIG. 2 is a schematic side view of the conveyor apparatus of FIG. 1.

FIG. 3 is a schematic view of the unwinding module of the conveyor apparatus of FIG. 1.

FIG. 4 is a schematic view of the first roller and the rotary encoder of the conveyor apparatus of FIG. 1.

FIG. 5 is a schematic view of the second roller and the meter wheel of the conveyor apparatus of FIG. 1.

FIG. 6A illustrates the testing result of the thin glass which is measured by the first load cell of the conveyor apparatus of FIG. 1.

FIG. 6B illustrates the testing result of the thin glass which is measured by the second load cell of the conveyor apparatus of FIG. 1.

FIG. 7A illustrates the testing result of the first position sensing unit of the conveyor apparatus of FIG. 1.

FIG. 7B illustrates the testing result of the second position sensing unit of the conveyor apparatus of FIG. 1.

### DESCRIPTION OF EMBODIMENTS

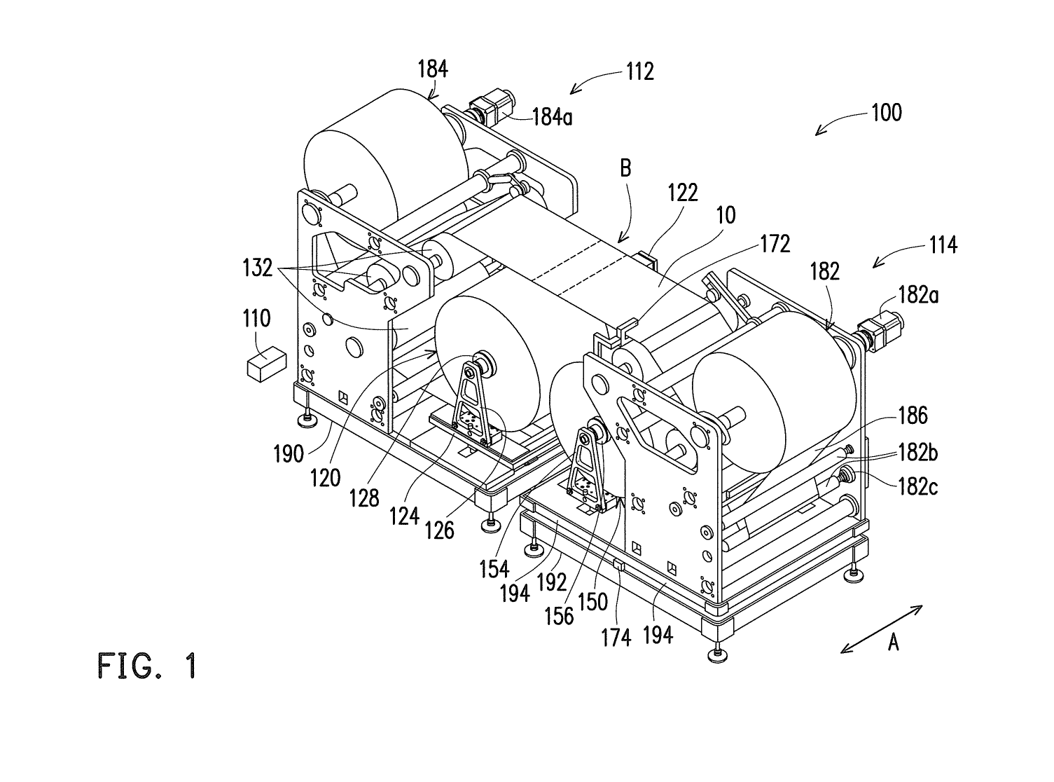

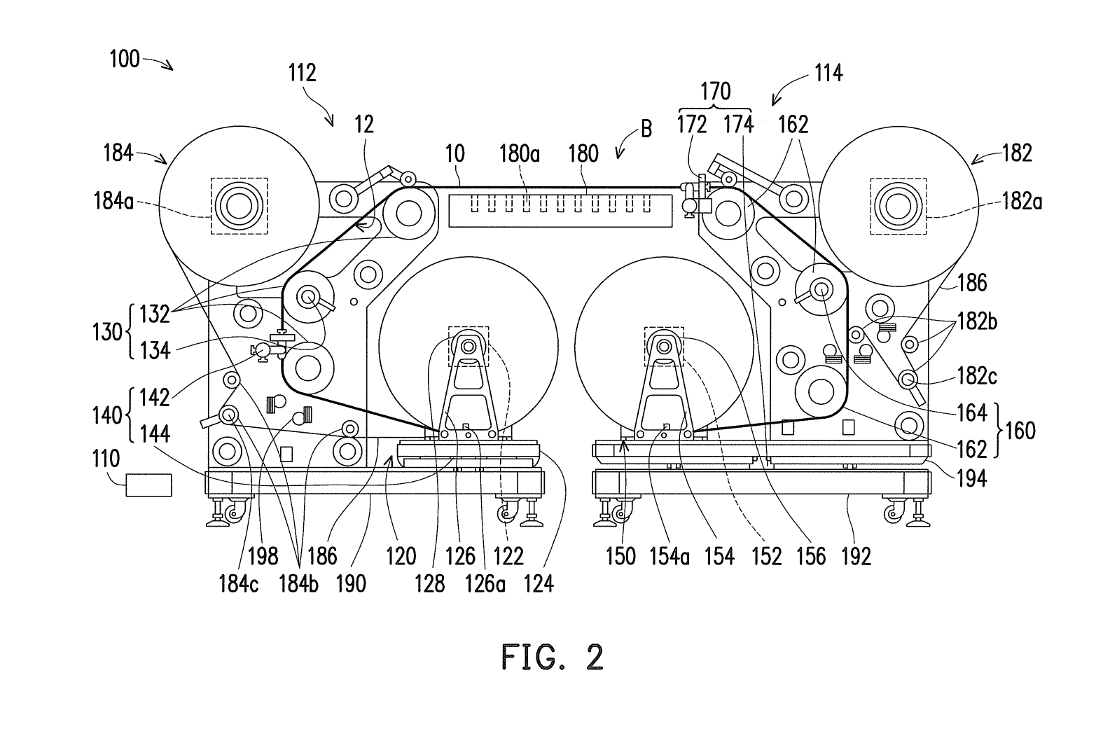

FIG. 1 schematically shows a perspective view of a conveyor apparatus according to an exemplary embodiment of the disclosure. FIG. 2 is a schematic side view of the conveyor apparatus of FIG. 1. Referring to FIG. 1 and FIG. 2, a conveyor apparatus 100 of the embodiment is suitable for conveying a thin glass 10. In the embodiment, the thin glass 10 can be a flexible substrate, wherein the material of the flexible substrate can be glass, polymer, metal or the like, and the disclosure is not limited thereto. In the embodiment, the thin glass 10 has a thickness not greater than 150 μm, particularly under 100 μm; a width not smaller than 100 mm, particularly above 200 mm; a length not smaller than 1 m, particularly above 10 m, but the dimension of the thin glass 10 is not limited thereto.

The conveyor apparatus 100 of the embodiment includes a control module 110, an unwinding mechanism 112 and a rewinding mechanism 114. The unwinding mechanism 112 includes a first unwinding module 120, a first tension sensing module 130 and a first misalignment guiding module 140. The rewinding mechanism 114 includes a rewinding module 150, a second tension sensing module 160 and a second misalignment guiding module 170.

The unwinding module 120 includes a first actuating unit 122, wherein the first actuating unit 122 is electrically connected to the control module 110. The first actuating unit 122 can be a servo motor, an inverter motor, a regulating speed motor or any other power system as long as speed and torque can be adjusted. The thin glass 10 wound as a glass spool is held by the unwinding module 120 and unwound via the first actuating unit 122.

The first tension sensing module 130 includes a first set of rollers and a first load cell 134. According to the embodiment, the first set of rollers includes at least three first rollers 132. In the embodiment, the three first rollers 132 are positioned so that a first wrap angle smaller than 180 degrees is formed when the thin glass 10 passes through the first rollers 132. The first load cell 134 is disposed at two ends of the first roller 132 located in the middle. The first load cell 134 can be connected outside or hidden in the two ends of the rollers and electrically connected to the control module 110. The first load cell 134 calculates the conveying tension of the thin glass 10 via the magnitude of subjected pressure. The first load cell 134 can transmit the measured tension value to the control module 110. Then the control module 110 may compare the difference between the measured tension and the target tension, and send signals so as to adjust the rotational speed or torque of the first actuating unit 122. In an exemplary embodiment, the range of the first wrap angle is between 90 degrees and 160 degrees, and preferably, the first wrap angle is 129 degrees.

The first misalignment guiding module 140 includes a first position sensing unit 142 and a third actuating unit 144 electrically connected to the control module 110. The first position sensing unit 142 is used for detecting the offset status of the thin glass 10. The first position sensing unit 142 may be a linear type sensor, an ultrasonic sensor, an optical sensor, an active charge-coupled device (CCD) or a compressed air flow rate detecting sensor. However, the type of the first position sensing unit 142 is not limited thereto. The third actuating unit 144 is used for driving the unwinding module 120 to move along an axis A perpendicular to the conveying direction of the thin glass 10. The third actuating unit 144 can be a power system capable of forward and reverse motion such as a servo motor, a reversible motor, a rotary cylinder, a linear motor, an air cylinder or a hydraulic cylinder.

The rewinding module 150 includes a second actuating unit 152, wherein the second actuating unit 152 is electrically connected to the control module 110. The second actuating unit 152 can be a servo motor, an inverter motor, a regulating speed motor or any other power system as long as speed and torque can be adjusted. After the thin glass 10 unwound from the unwinding module 120 passes through the first rollers 132, the thin glass 10 can pass through a processing area B for printing process, laser process or lamination process, then the thin glass 10 is wound into the rewinding module 150 via the second actuating unit 152.

The second tension sensing module 160 includes a second set of rollers and a second load cell 164. In the embodiment, the second set of rollers includes at least three second rollers 162, and the three second rollers 162 are positioned so that a second wrap angle smaller than 180 degrees is formed when the thin glass 10 passes through the second rollers 162. The second load cell 164 is disposed at two ends of the second roller 162 located in the middle. The second load cell 164 can be connected outside or hidden in the two ends of the rollers and electrically connected to the control module 110. The second load cell 164 calculates the conveying tension of the thin glass 10 via the magnitude of subjected pressure. The second load cell 164 can transmit the measured tension value to the control module 110. Then the control module 110 may compare the difference between the measured tension and the target tension, and send signals so as to adjust the rotational speed or torque of the second actuating unit 152. In an exemplary embodiment, the range of the second wrap angle is between 90 degrees and 160 degrees, and preferably, the second wrap angle is 128 degrees. In addition, it has to be mentioned that, the first wrap angle and the second wrap angle mentioned in the embodiment are not the same, but both are still between 90 degrees and 160 degrees. In another embodiment which is not shown with figures, through the control of the position of the rollers, the first wrap angle formed when the thin glass passes through the first rollers and the second wrap angle formed when the thin glass passes through the second rollers can be formed equal to each other.

The second misalignment guiding module 170 includes a second position sensing unit 172 and a fourth actuating unit 174 electrically connected to the control module 110. The second position sensing unit 172 is used for detecting the offset status of the thin glass 10. The second position sensing unit 172 may be a linear type sensor, an ultrasonic sensor, an optical sensor, an active charge-coupled device (CCD) or a pressure flow sensor. However, the type of the second position sensing unit 172 is not limited thereto. The fourth actuating unit 174 is used for driving the rewinding module 150 to move along the axis A. The fourth actuating unit 174 can be a power system capable of forward and reverse motion such as a servo motor, a reversible motor, a rotary cylinder, a linear motor, an air cylinder or a hydraulic cylinder.

The thin glass 10 in the roll-to-roll processing apparatus is affected by the factors such as the parallelism between the first rollers 132 and the second rollers 162, uniformity of the tension or deformation of the thin glass 10, so that the thin glass 10 is easy to offset laterally or vacillate during conveyance. Therefore, it is necessary to appropriately correct the position of the thin glass 10 through the first misalignment guiding module 140 and the second misalignment guiding module 170, nearby the unwinding module 120, the processing area B and the rewinding module 150, in order that the thin glass 10 can be conveyed stably according to a specific reference conveying path, so as to ensure the position accuracy of the product in the processing area B and to improve the rewinding quality of the thin glass 10. The function of the first position sensing unit 142 and the second position sensing unit 172 is to determine whether the edge of the thin glass 10 is beyond the preset range. A direct driving method can be used for correcting the unwinding module 120 and the rewinding module 150 to drive the unwinding module 120 and the rewinding module 150 to perform offsetting laterally, so that the misalignment of conveying direction of the thin glass 10 can be corrected.

In addition, in order to avoid the breakage of the thin glass 10 due to the alternating tensile and compressive stress applying on the thin glass 10 because the upper and lower surfaces of the thin glass 10 are repeatedly contact with the first rollers 132 and the second rollers 162, and in order to avoid the processed surface being contact with the rollers during the specific fabricating process (e.g., coating process), in the embodiment, alternately conveying method is avoided in the conveying path of the thin glass 10. In other words, the thin glass 10 is conveyed in a manner that merely one surface 12 (the lower surface as shown in FIG. 2) of the thin glass 10 is contact with the first rollers 132 and the second rollers 162, so as to reduce the possibility of breakage due to the alternating tensile and compressive stress subjected to the thin glass 10 or to avoid the chance of the processed surface caused damage.

Giving consideration to during the conveyance, when the thin glass 10 passed through the first rollers 132 and the second rollers 162, small dimension of the first rollers 132 and the second rollers 162 may cause the thin glass 10 to have a larger bending stress and so that the difference between the tensile stress and the compressive stress subjected to the upper and lower surfaces of the thin glass 10 may be increased and the thin glass 10 may be broken. In order to reduce the above mentioned circumstances, in the embodiment, the diameter of each of the first rollers 132 and the second rollers 162 is greater than 3 inches, so as to reduce the bending stress of the thin glass 10.

During the conveyance of the thin glass 10, if foreign materials enter between the thin glass 10 and the first rollers 132 or the second rollers 162, or if there is a slip between the thin glass 10 and the first rollers 132 or the second rollers 162, the surface of the thin glass 10 may get scrapes. For the application field of the flexible electronic products, the thin glass 10 is required to be performed by processes such as electronic screen printing, laminating, exposure, developing, etching and the like according to different products. Thus, the scrapes may cause defects like the electric circuit damage and the display transparency decrease.

In order to avoid above mentioned circumstances, in the embodiment, the conveyor apparatus 100 further includes an air floating stage 180 disposed in the processing area B which is located between the first rollers 132 and the second rollers 162. The air floating stage 180 is used for spouting out airflow, so as to avoid the scraping between the thin glass 10 and the mechanisms or components of the processing area B. The air floating stage 180 includes a porous surface 180a, wherein the material of the porous surface 180a may be ceramic, metal, high polymer or fiber. Porous surface may be achieved by using the powder metallurgy or drilling holes on metal plates. In the embodiment, the conveyor apparatus 100 can reduce the conveying dragging force of the thin glass 10 and the possibility of surface scraping through the air floating stage 180. In addition, the width of the air floating stage 180 may correspond to the width of the thin glass 10, so as to provide the thin glass 10 a better floating effect.

Additionally, the thin glass 10 is wound to the unwinding module 120 and the rewinding module 150 in layered structure, in order to reduce scrapes caused to each layer due to direct contact. The conveyor apparatus 100 of the embodiment further includes a medium layer unwinding module 182, a medium layer rewinding module 184 and a medium layer 186. The medium layer 186 can be plastic, and each layer of the thin glass 10 can be protected by attaching the medium layer 186 to the thin glass 10 so as to reduce the possibility of scrapes between the layers of thin glass 10.

The medium layer unwinding module 182 includes a fifth actuating unit 182a, wherein the fifth actuating unit 182a is electrically connected to the control module 110. The fifth actuating unit 182a includes a servo motor, an inverter motor, a regulating speed motor or any other power system as long as speed can be adjusted. As shown in FIG. 2, the medium layer unwinding module 182 is disposed at a side of the rewinding module 150, wherein the wound medium layer 186 is set up around the medium layer unwinding module 182, the first actuating unit 182a drives the medium layer 186 to be unwound from the medium layer unwinding module 182, and the medium layer 186 is wound into the rewinding module 150 together with the thin glass 10.

Similarly, the medium layer 186 is wound between each layer of the thin glass 10 of the unwinding module 120, if the layers of the thin glass 10 are separated by the medium layer 186 to reduce scraping, when the thin glass 10 is unwound, the medium layer 186 may be unwound simultaneously. The medium layer 186 is wound by using the medium layer rewinding module 184. The medium layer rewinding module 184 is disposed at a side of the unwinding module 120, wherein the medium layer rewinding module 184 includes a sixth actuating unit 184a, and the sixth actuating unit 184a is electrically connected to the control module 110. The sixth actuating unit 184a can be a servo motor, an inverter motor, a regulating speed motor or any other power system as long as speed can be adjusted. After the medium layer 186 is unwound from the unwinding module 120 together with the thin glass 10, the medium layer 186 is wound into the medium layer rewinding module 184 by the driving of the sixth actuating unit 184a.

In order to maintain the tension of the medium layer 186 during conveyance, in the embodiment, the medium layer unwinding module 182 further includes at least three third rollers 182b and a third load cell 182c, the third load cell 182c is disposed on one third roller 182b located at middle of the at least three third rollers 182b and electrically connected to the control module 110. In addition, the medium layer rewinding module 184 further includes at least three fourth rollers 184b and a fourth load cell 184c, the fourth load cell 184c is disposed on the third roller 184b located at middle and electrically connected to the control module 110. As such configuration, the medium layer 186 is disposed between each layer of the thin glass 10 to stabilize the conveying tension. In addition, besides the layers of the thin glass 10 being separated by the medium layer 186 during rewinding condition, attaching plastic materials on the edge can also increase the strength and reduce the possibility of breakage during conveyance.

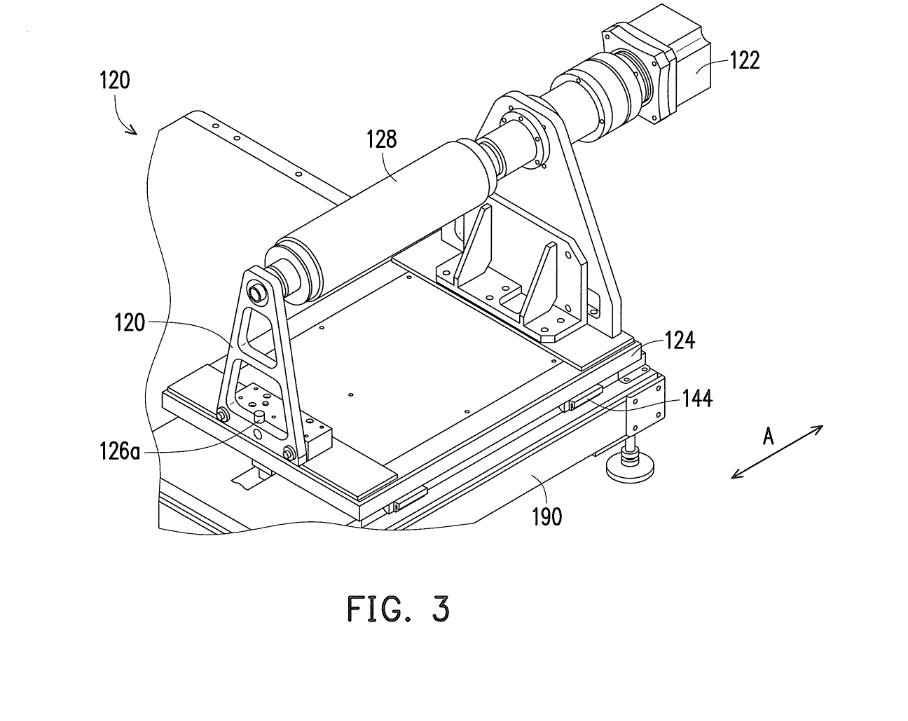

The conveyor apparatus of the embodiment further includes a first base 190, a second base 192 and a second moving stage 194. The unwinding module 120, the first tension sensing module 130 and the first misalignment guiding module 140 are located on the first base 190. FIG. 3 is a schematic view of the unwinding module of the conveyor apparatus of FIG. 1. The unwinding module 120 further includes a first moving stage 124, a first quick release plate 126 and a first air shaft 128. When the thin glass 10 misaligns while unwinding, the third actuating unit 144 may drive the first moving stage 124 to move along the axis A related to the first base 190. The first quick release plate 126 is detachably disposed on the first moving stage 124, wherein an end of the first air shaft 128 is connected to the first actuating unit 122 and the other end of the first air shaft 128 is pivoted to the first quick release plate 126, and the roll of the thin glass 10 can be wound around the first air shaft 128.

As shown in FIG. 1 and FIG. 2, in the embodiment, after leaving the processing area B, the thin glass 10 may pass through the second position sensing unit 172, and via the second position sensing unit 172 the offset status of the thin glass 10 in the processing area B may be measured and transmitted to the control module 110. When the control module 110 determines that there is a misalignment status, the control module 110 may send signals so that the fourth actuating unit 174 drives the second moving stage 194 to move along the axis A related to the second base 192 for correcting the misalignment. The proceeding tension measurement and rewinding process are performed after the thin glass 10 is corrected its misalignment. Therefore, in the embodiment, the first moving stage 124 merely carries the unwinding module 120, and the second moving stage 194 carries the rewinding module 150, the second tension sensing module 160 and the second misalignment guiding module 170.

In order to facilitate taking off the roll of thin glass 10 from the rewinding module 150 after the thin glass 10 is wound by the rewinding module 150, in the embodiment, the rewinding module 150 further includes a second quick release plate 154 and a second air shaft 156. The second quick release plate 154 is detachably disposed on the second moving stage 194, wherein the thin glass 10 is wound around the second air shaft 156, and an end of the second air shaft 156 is connected to the second actuating unit 152 and the other end of the second air shaft 156 is pivoted to the second quick release plate 154.

In the embodiment, the thin glass 10 is unwound from the first air shaft 128 and wound into the second air shaft 156, and the first quick release plate 126 and the second quick release plate 154 are respectively located at a side of the first air shaft 128 and the second air shaft 156 so as to assist in supporting the edges of the thin glass 10. Positioning pins 126a, 154a are used for positioning of the first quick release plate 126 and the first moving stage 124, and the second quick release plate 154 and the second moving stage 194, respectively. When the roll of the thin glass 10 is put onto the first air shaft 128 or taken off from the second air shaft 156, by removing the positioning pins 126a, 154a, the first quick release plate 126 and the second quick release plate 154 can be detached, and in this way the roll of thin glass 10 is easily placed and detached. Furthermore, bearings on the first quick release plate 126 and the second quick release plate 154 are pivoted to the first air shaft 128 and the second air shaft 156, so as to increase the stability of the roll of the thin glass 10 during rotation.

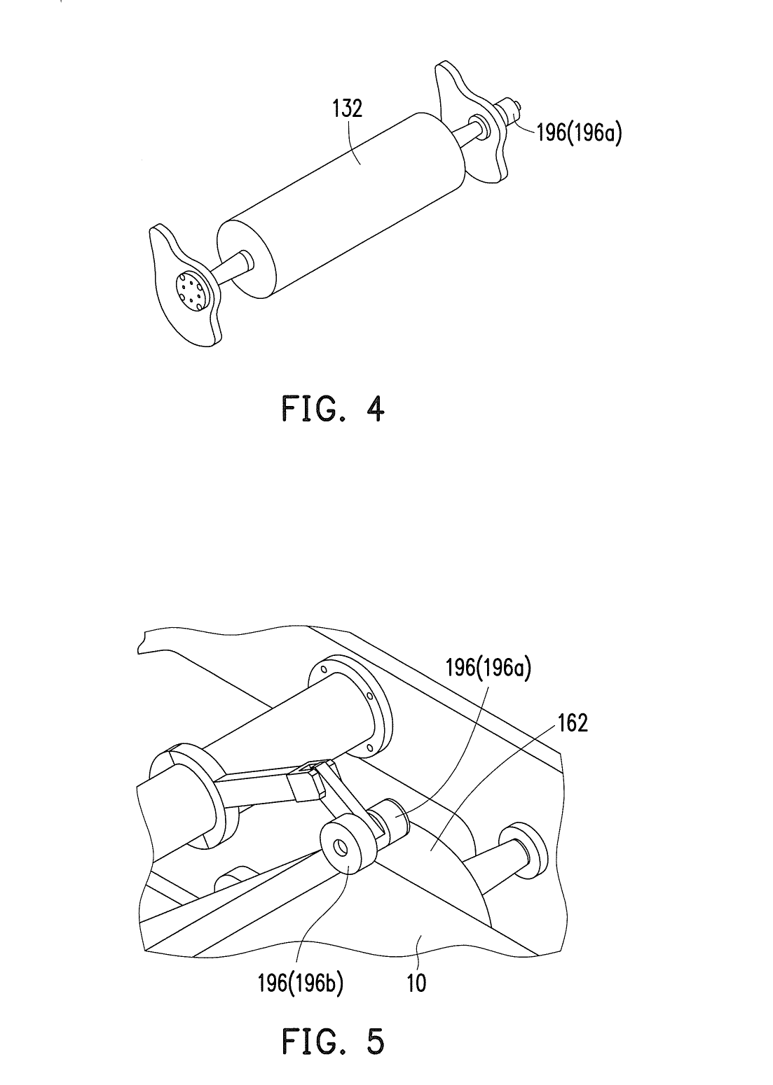

The conveyor apparatus 100 further includes a speed measuring module 196 electrically connected to the control module 110. The speed measuring module 196 is used for measuring a conveying speed of the thin glass 10. The speed measuring module 196 can be a rotary encoder 196a or a meter wheel 196b. FIG. 4 is a schematic view of the first roller and the rotary encoder of the conveyor apparatus of FIG. 1. Referring to FIG. 4, the rotary encoder 196a is disposed on an end of the first roller 132 and calculates the conveying speed of the thin glass 10 through the revolution numbers of the rotation of the first roller 132 in a preset time period. FIG. 5 is a schematic view of the second roller and the meter wheel of the conveyor apparatus of FIG. 1. Referring to FIG. 5, the meter wheel 196b is contact with the second rollers 162 or the thin glass 10, so as to directly measure the moving distance of the thin glass 10 in a preset time period to obtain the conveying speed of the thin glass 10. In other embodiments, a yard wheel can also be used instead of the meter wheel 192b, and the type of speed measuring module 196 is not limited thereto. The speed measuring module 196 transmits the signals to the control module 110 after the conveying speed of the thin glass 10 is measured, and the control module 110 may correct the rotational speed or torque of the first actuating unit 122 and the second actuating unit 152 according to the measurement value. In addition, the control module 110 may also control the first actuating unit 122 and the second actuating unit 152 to continuously convey the glass in a constant speed, or interruptedly convey in a jog movement method. Herein the first rollers 132 may be the second rollers 162, and the second rollers 162 may also be the first rollers 132.

Referring to FIG. 2, in the embodiment, the conveyor apparatus 100 further includes an ionizer 198, wherein the ionizer 198 is disposed at a side of the unwinding module 120, the first rollers 132, the second rollers 162 or the rewinding module 150. The ionizer 198 is used for releasing the residual static electricity of the surface of the thin glass 10 when the thin glass 10 is unwound from the unwinding module 120, wound into the rewinding module 150, or conveyed by the first rollers 132 or the second rollers 162 during the conveying process.

In the embodiment, the control module 110 can control the conveying tension and the conveying speed of the thin glass 10, correct the offset of the thin glass 10 during conveying, and actuate the relative components of the conveyor apparatus 100, for example, the air floating stage 180 and the ionizer 198. However, the components controlled by the control module 110 are not limited thereto.

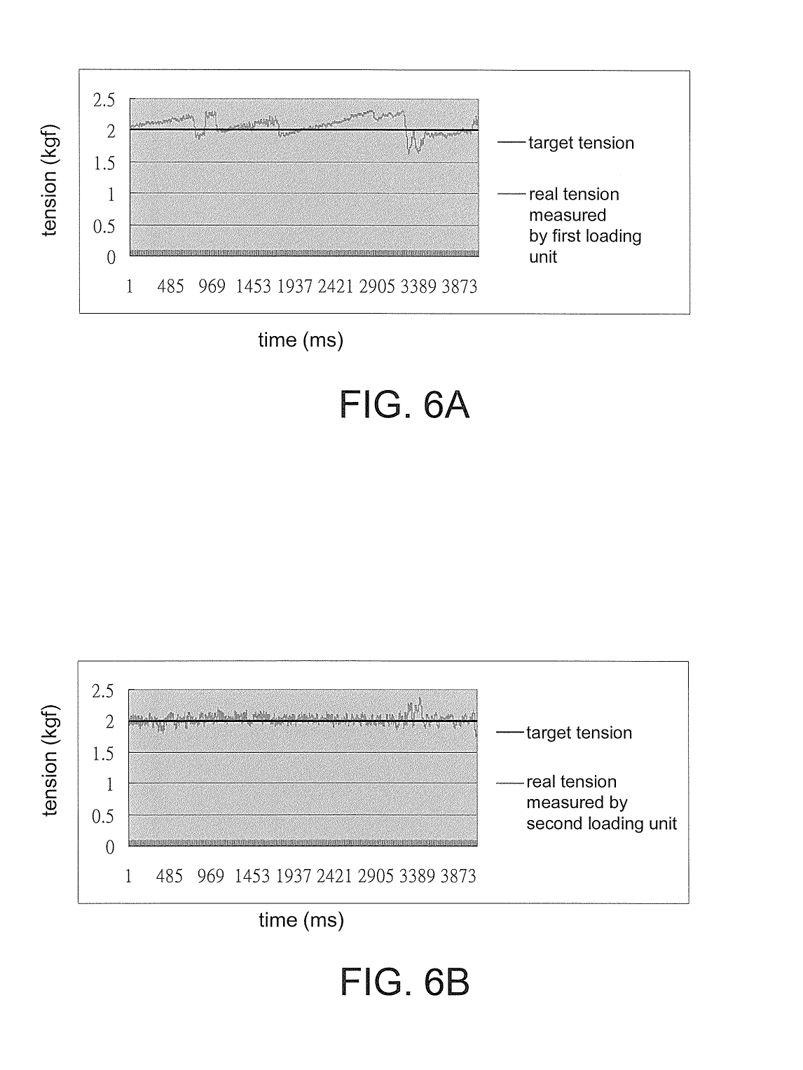

In addition, in the embodiment, the tension of the thin glass 10 of the conveyor apparatus 100 can be controlled in the following manner, first, the first load cell 134 or the second load cell 164 reads the tension value of the thin glass 10 on the first rollers 132 or the second rollers 162, and then the result is sent to the control module 110. Next, the control module 110 compares the target tension and the measured tension value for calculating the relative tension error value. After that, the control module 110 adjusts the rotational speed or torque of the first actuating unit 122 and the rotational speed or torque of the second actuating unit 152, so as to perform the tension control. FIG. 6A illustrates the testing result of the thin glass which is measured by the first load cell of the conveyor apparatus of FIG. 1. FIG. 6B illustrates the testing result of the thin glass which is measured by the second load cell of the conveyor apparatus of FIG. 1. Referring to FIG. 6A and FIG. 6B, before the unwinding and after the winding, the tension values of the thin glass 10 are substantially very close to the target tension. As such, the conveyor apparatus 100 of the embodiment can stably perform the conveyance of the thin glass 10.

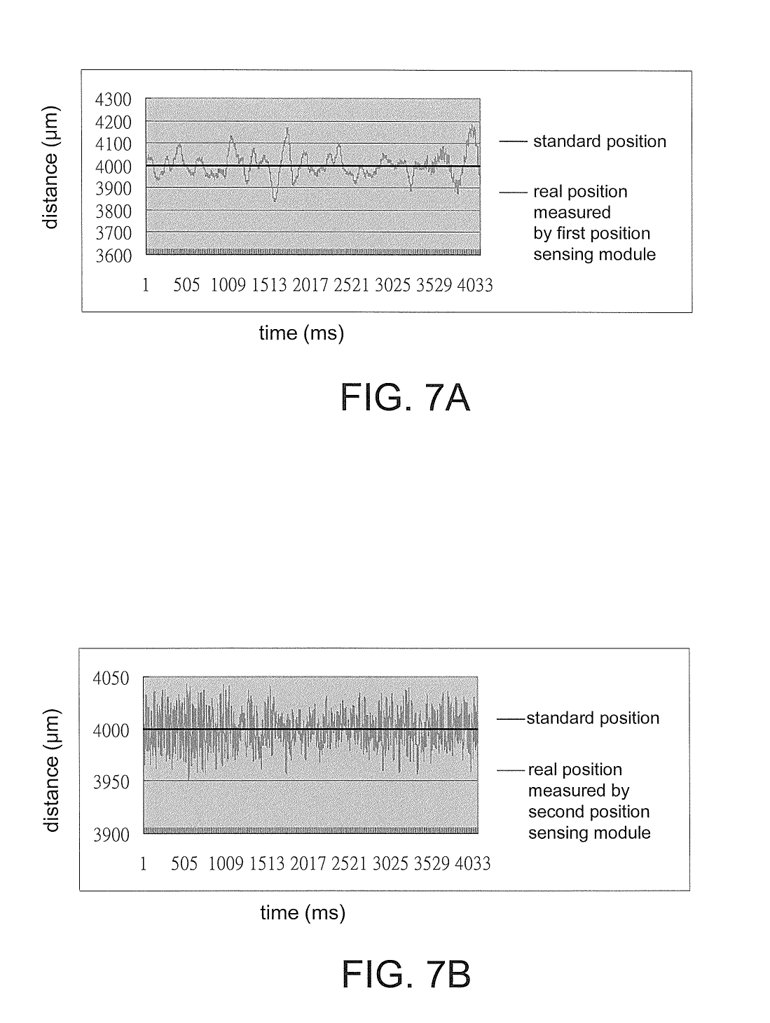

Moreover, the position of the thin glass 10 of the conveyor apparatus 100 described in the embodiment can be controlled by the following method. First, the measurement values related to the edge position of the thin glass 10 of the first position sensing unit 142 and the second position sensing unit 172 are read, and the result is sent to the control module 110. Next, the control module 110 compares the standard position and the measured value for calculating the offset of the edge position of the thin glass 10. Next, the control module 110 controls the third actuating unit 144 or the fourth actuating unit 174 to correct the unwinding module 120 or the rewinding module 150. FIG. 7A illustrates the testing result of the first position sensing unit of the conveyor apparatus of FIG. 1. FIG. 7B illustrates the testing result of the second position sensing unit of the conveyor apparatus of FIG. 1. The position at 4000 μm of the vertical axis of FIG. 7A and FIG. 7B represents the standard position of the edge of the thin glass 10. As shown in FIG. 7A and FIG. 7B, after being unwound and passing through the processing area B, the edge of the thin glass 10 can be maintained at the position very close to the standard position.

The control module 110 of the conveyor apparatus 100 of the embodiment drives the first actuating unit 122 to drive the first air shaft 128 to rotate, so that the thin glass 10 may pass through the first rollers 132 after the thin glass 10 is unwound from the unwinding module 120. Then the first load cell 134 detects the tension value of the thin glass 10 and the first position sensing unit 142 detects the edge position of the thin glass 10, and the first load cell 134 and the first position sensing unit 142 respectively response the results to the control module 110. The control module 110 can adjust the rotational speed or torque level of the first actuating unit 122 so as to change the tension of the thin glass 10, and control the third actuating unit 144 so that the first moving stage 124 moves laterally to achieve the effect of adjustment. Then, the thin glass 10 is conveyed to the processing area B for printing process, laser process, lamination process, or the like. After the thin glass 10 leaves the processing area B, the second position sensing unit 172 detects the edge position of the thin glass 10, so as to ensure the position of the thin glass 10 is correct. If offset occurs, the control module 110 can control the fourth actuating unit 174 to drive the second moving stage 194 laterally to preset position. Next, the thin glass 10 passes through the second rollers 162. The second load cell 164 detects the tension value of the thin glass 10 before the thin glass 10 is wound and responds the tension value to the control module 110. The control module 110 adjusts the rotational speed or torque level of the second actuating unit 152 so as to change the tension of the thin glass 10. Finally, the thin glass 10 is wound into the second air shaft 156 of the rewinding module 150.

In light of the foregoing, in the conveyor apparatus of the disclosure, the conveying tension of the thin glass between the rewinding module and the unwinding module is determined by the rotational speed or torque level of the first actuating unit and the second actuating unit controlled by the control module. Via the three first rollers and the three second rollers, constant wrap angles are formed, respectively. The first load cell and the second load cell can detect the tension value of the thin glass under the wrap angles and feed back to the control module, so that the tension of the thin glass can be controlled to be in a certain range by the control module, so that the thin glass is stably conveyed. Furthermore, in the conveyor apparatus of the disclosure, through the first position sensing unit and the second position sensing unit detecting the offset status of the thin glass and the feed back to the control module, the control module controls the third actuating unit or the fourth actuating unit to drive the unwinding module or the rewinding module to move to a reverse direction of the offset direction, and the offset of the thin glass can be reduced. In addition, the thin glass is contact with the first rollers and the second rollers merely by one single surface, so as to reduce the possibility of breakage occurrence of the thin glass when the thin glass is alternately subjected to a tensile and compressive force during the conveying process, so as to avoid the chance of damage of the processed surface. Moreover, through the spouting out airflow to the surface of the thin glass by using the air floating stage, the possibility of scraping between the thin glass and the mechanism or components in the conveying area and the processing area is reduced, and facility of guiding the thin glass is improved. The thin glass of the disclosure can be any other flexible substrate, wherein the material of the flexible substrate can be glass, high polymer, metal or the like, and the disclosure is not limited thereto.

Although the disclosure has been described with reference to the above embodiments, it is apparent to one of the ordinary skill in the art that modifications to the described embodiments may be made without departing from the spirit of the disclosure. Accordingly, the scope of the disclosure will be defined by the attached claims not by the above detailed descriptions.

What is claimed is:

1. A conveyor apparatus, suitable for conveying an object along a conveying path, the conveyor apparatus comprising:
a control module;
an unwinding module comprising a first actuating unit, wherein the first actuating unit is electrically connected to the control module, the object is wound around the unwinding module, via the first actuating unit the object is unwound and conveyed through the conveying path;
a rewinding module, the conveying path connected between the unwinding module and the rewinding module, wherein the rewinding module comprises a second actuating unit, the second actuating unit is electrically connected to the control module, via the second actuating unit the object is conveyed through the conveying path and wound into the rewinding module; and
at least one tension sensing module disposed on the conveying path, wherein the at least one tension sensing module comprises a set of rollers and a load cell, the load cell is disposed at the set of rollers and electrically connected to the control module, and a surface of the object is contact with the set of rollers and a wrap angle less than 180 degrees is formed along the set of rollers.

2. The conveyor apparatus as claimed in claim 1, wherein the at least one tension sensing module comprises a first tension sensing module, the first tension sensing module comprises at least three first rollers and a first load cell, the first load cell is disposed on one first roller located at middle of the at least three first rollers, and the surface of the object is contact with the at least three first rollers and the object is conveyed.

3. The conveyor apparatus as claimed in claim 1, wherein the at least one tension sensing module comprises a second tension sensing module, the second tension sensing module comprises at least three second rollers and a second load cell, the second load cell is disposed on one second roller located at middle of the at least three second rollers, and the surface of the object is contact with the at least three second rollers and the object is conveyed.

4. The conveyor apparatus as claimed in claim 1, wherein the at least one tension sensing module comprises a first tension sensing module and a second tension sensing module, the first tension sensing module comprises at least three first rollers and a first load cell, the first load cell is disposed on one first roller located at middle of the at least three first rollers, the second tension sensing module comprises at least three second rollers and a second load cell, the second load cell is disposed on one second roller located at middle of the at least three second rollers, and the surface of the object is contact with the at least three first rollers and the at least three second rollers and the object is conveyed.

5. The conveyor apparatus as claimed in claim 2, wherein a diameter of each of the at least three first rollers is greater than 3 inches.

6. The conveyor apparatus as claimed in claim 3, wherein a diameter of each of the at least three second rollers is greater than 3 inches.

7. The conveyor apparatus as claimed in claim 4, wherein a diameter of each of the at least three first rollers and second rollers is greater than 3 inches.

8. The conveyor apparatus as claimed in claim 1, wherein a range of the wrap angle is substantially between 90 degrees and 160 degrees.

9. The conveyor apparatus as claimed in claim 1, further comprising:
at least one misalignment guiding module disposed on the conveying path, wherein each of the at least one misalignment guiding module is adapted to detect a offset status of the object during being unwound or wound and control the object to move along an axis which is perpendicular to the conveying direction of the object.

10. The conveyor apparatus as claimed in claim 9, wherein the at least one misalignment guiding module comprises a first misalignment guiding module, the first misalignment guiding module comprises a first position sensing unit and a third actuating unit electrically connected to the control module, the first position sensing unit is used for detecting the offset status of the object, and the third actuating unit is used for driving the unwinding module to move along the axis.

11. The conveyor apparatus as claimed in claim 10, further comprising:
a first base, wherein the unwinding module, the at least one tension sensing module and the first misalignment guiding module are located on the first base.

12. The conveyor apparatus as claimed in claim 11, wherein the unwinding module further comprises a first moving stage, the third actuating unit is adapted to drive the first moving stage to move along the axis related to the first base.

13. The conveyor apparatus as claimed in claim 12, wherein the unwinding module further comprises a first quick release plate and a first air shaft, the first quick release plate is detachably disposed on the first moving stage, an end of the first air shaft is connected to the first actuating unit, another end of the first air shaft is pivoted to the first quick release plate, and the object is adapted to be wound around the first air shaft.

14. The conveyor apparatus as claimed in claim 9, wherein the at least one misalignment guiding module comprises a second misalignment guiding module, the second misalignment guiding module comprises a second position sensing unit and a fourth actuating unit electrically connected to the control module, the second position sensing unit is used for detecting the offset status of the object, and the fourth actuating unit is used for driving the rewinding module to move along the axis direction.

15. The conveyor apparatus as claimed in claim 14, further comprising:
a second base; and
a second moving stage disposed on the second base and moving along the axis, wherein the fourth actuating unit is adapted to drive the second moving stage to move along the axis related to the second base, and the rewinding module, the at least one tension sensing module and the second misalignment guiding module are located on the second moving stage.

16. The conveyor apparatus as claimed in claim 15, wherein the rewinding module further comprises a second quick release plate and a second air shaft, the second quick release plate is detachably disposed on the second moving stage, an end of the second air shaft is connected to the second actuating unit, another end of the second air shaft is pivoted to the second quick release plate, and the object is adapted to be wound around the second air shaft.

17. The conveyor apparatus as claimed in claim 9, wherein the at least one misalignment guiding module comprises a first misalignment guiding module and a second misalignment guiding module, the first misalignment guiding module comprises a first position sensing unit and a third actuating unit electrically connected to the control module, the second misalignment guiding module comprises a second position sensing unit and a fourth actuating unit electrically connected to the control module, the first position sensing unit and the second position sensing unit are used for detecting the offset status of the object, the third actuating unit is used for driving the unwinding module to move along the axis, and the fourth actuating unit is used for driving the rewinding module to move along the axis.

18. The conveyor apparatus as claimed in claim 17, further comprising:
a first base, wherein the unwinding module, the at least one tension sensing module and the first misalignment guiding module are located on the first base.

19. The conveyor apparatus as claimed in claim 18, wherein the unwinding module further comprises a first moving stage, the third actuating unit is adapted to drive the first moving stage to move along the axis related to the first base.

20. The conveyor apparatus as claimed in claim 19, wherein the unwinding module further comprises a first quick release plate and a first air shaft, the first quick release plate is detachably disposed on the first moving stage, an end of the first air shaft is connected to the first actuating unit, another end of the first air shaft is pivoted to the first quick release plate, and the object being a winding shape is adapted to be wound around the first air shaft.

21. The conveyor apparatus as claimed in claim 17, further comprising:
a second base; and
a second moving stage disposed on the second base and moving along the axis, wherein the fourth actuating unit is adapted to drive the second moving stage to move along the axis related to the second base, and the rewinding module, the at least one tension sensing module and the second misalignment guiding module are located on the second moving stage.

22. The conveyor apparatus as claimed in claim 21, wherein the rewinding module further comprises a second quick release plate and a second air shaft, the second quick release plate is detachably disposed on the second moving stage, an end of the second air shaft is connected to the second actuating unit, another end of the second air shaft is pivoted to the second quick release plate, and the object is adapted to be wound around the second air shaft.

23. The conveyor apparatus as claimed in claim 1, further comprising:
a medium layer unwinding module comprising a fifth actuating unit, wherein the fifth actuating unit is electrically connected to the control module, so that a medium layer is unwound from the medium layer unwinding module, and the medium layer is adapted to be wound around the rewinding module together with the object.

24. The conveyor apparatus as claimed in claim 23, wherein the medium layer unwinding module further comprises at least three third rollers and a third load cell, the third load cell is disposed on one third roller located at middle of the at least three third rollers and electrically connected to the control module.

25. The conveyor apparatus as claimed in claim 1, further comprising:
a medium layer rewinding module comprising a sixth actuating unit, wherein the sixth actuating unit is electrically connected to the control module, a medium layer is unwound from the unwinding module, and via the sixth actuating unit the medium layer is wound around the medium layer rewinding module.

26. The conveyor apparatus as claimed in claim 25, wherein the medium layer rewinding module further comprises at least three fourth rollers and a fourth load cell, the fourth load cell is disposed on one fourth roller located at middle of the at least three fourth rollers and electrically connected to the control module.

27. The conveyor apparatus as claimed in claim 1, further comprising:
a speed measuring module electrically connected to the control module, wherein the speed measuring module is used for measuring a conveying speed of the object.

28. The conveyor apparatus as claimed in claim 1, further comprising:
an ionizer disposed at a side of the unwinding module, the set of rollers or the rewinding module, so as to release a residual electrostatic charge of the surface of the object.

29. The conveyor apparatus as claimed in claim 1, wherein the object is a thin glass having a thickness smaller than 150 μm, a width greater than 100 mm and a length greater than 1 m.

30. The conveyor apparatus as claimed in claim 1, further comprising:
at least one air floating stage disposed on the conveying path, wherein the air floating stage is adapted to spout out an airflow, so that a distance exists between the object and the at least one air floating stage.
